(19) United States
(12) Patent Application Publication
(10) Pub. No.: US 2002/0128832 A1
(43) Pub. Date: Sep. 12, 2002

(54) Compact speech module

(75) Inventor: Bruce A. Smith, Austin, TX (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/788,844

(22) Filed: Feb. 20, 2001

(51) Int. Cl. G10L 15/00

(52) U.S. Cl. 704/231

(57) ABSTRACT

The present invention discloses a form factor for a compact speech processing module having a processor, high speed memory, a speech recognition engine, audio processing circuitry and a computing device interface to facilitate connection to a host device. The host device can be a handheld device (palm device or personal digital assistant), into which the compact speech module can be plugged. The compact speech module can process speech independently of or in conjunction with the host device. Voice input commands processed by the speech module can be communicated to the host device to execute various tasks.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

The present invention relates to the field of speech processing, and more particularly, to compact speech processing.

2. Description of the Related Art

The need for low cost mobile computing devices compounded with the ability to fit high powered computing electronics into much smaller footprints, has resulted in a proliferation of handheld devices, of which personal digital assistants (PDA) and palm held devices are members. While these handheld devices can provide instant access to information, the compact footprint or form factor of these devices make it inconvenient for users to speedily and efficiently enter user information or data.

Some manufacturers of handheld devices have created various scripting techniques that allow shorthand representation of letters of the alphabet in order to facilitate speedy entry. This enables users to utilize a stylus or pen based device to enter information via a touch sensitive area of the display screen on the device. Even though the scripting language might easily be learned, the advantage to users is minimal since the shorthand letter notations have to be individually entered. The same drawbacks are inherent in software keyboards that require a user to individually locate and activate each letter.

Alternately, some manufacturers have built in manual keyboards on the handheld devices. While the keys on these keyboards are mapped to the standard “QWERTY” keyboard, the size of the keyboard makes it inconvenient for a user to conveniently type the information. Increasing the size of the keyboard is not a practical solution since this would increase the size of the device.

An alternate solution for providing a convenient user input is to use a keyboard that can be a peripheral to the handheld device. The peripheral keyboard can be connected to the handheld device via a cable, or alternately, via a connector into which the handheld device can be plugged. The drawback with this solution is that the keyboard has to be transported along with the device. One partial solution used by vendors is to provide a folding keyboard. While this diminishes the size of the peripheral, the user must still carry the peripheral keyboard, which can be at least equivalent in size to the handheld device.

Thus, given the inherent drawbacks associated with entering data into handheld devices, there exists a need for a device that can speedily and efficiently facilitate entering information into these devices.

### SUMMARY OF THE INVENTION

The invention comprises a form factor for a compact speech module for use with a host computing device. The compact speech module can have a housing, a controller located within the housing, a memory for storing program code and data, the memory being interconnected to the controller, and audio processing circuitry interconnected to the controller and the memory, wherein the audio processing circuitry can be configured to convert analog audio signals to digital audio data signals, and to convert digital audio data signals to analog audio signals. The compact speech module can also have a speech recognition engine stored in the memory and the speech recognition engine can be used for processing the digital audio data signals into speech recognized signals. Notably, the speech recognition engine can be communicated to the host computing device for execution. Alternatively, the speech recognition engine can execute within the compact speech module. A computing device interface interconnected to the controller can act as a detachable connection for connecting the compact speech module to the host computing device, and as an interface through which the speech recognized data signals can be communicated to the host device.

The controller of the compact speech module can be either a microprocessor, a micro-controller, an ASIC and a FPGA. The audio processing circuitry can have electronic circuits for receiving an analog input speech signal and converting the analog input signal to a digital signal, and for receiving a digital signal of speech and converting the received digital signal to an analog speech signal. In one aspect of the invention, the audio processing circuitry can have electronic circuits for receiving analog input speech signals and converting the signals to a 16-bit digital signal, and for receiving a 16-bit digital signal of speech and converting the 16-bit digital signal to an analog speech signal. The electronics making up the audio processing circuitry can be an integrated circuit.

The audio processing circuitry can further contain a programmable microphone gain, and/or an output attenuator and/or a serial communication interface. The microphone gain circuitry can be connected to an externally accessible microphone connector which can be located on the outside of the housing. Similarly, the output attenuator circuitry can be connected to an externally accessible speaker connector which can be located on the outside of the housing. Still, the output attenuator circuitry and the programmable microphone gain circuitry can be connected to a single headset connector.

Additionally, the controller of the compact speech module can have circuitry to control the communication of signals between the memory and the audio processing circuitry, and between the memory and the host device via the computing device interface. The speech recognition engine can reside in the memory used for storing code and data. The memory can be a high speed memory device which can be used to store digitized speech data, for example, a flash type memory device.

The computing device interface of the compact speech module can be located at the periphery of the housing. Furthermore, the microphone connected to the audio processing circuitry can be located on the housing. Similarly, the speaker connected to the audio processing circuitry can also be located on the housing.

### BRIEF DESCRIPTION OF THE DRAWINGS

There are presently shown in the drawings embodiments which are presently preferred, it being understood, however, that the invention is not so limited to the precise arrangements and instrumentalities shown, wherein:

FIG. 1A is a block diagram illustrating the components of a compact speech module in accordance with one aspect of the present invention.

FIG. 1B is a block diagram illustrating the components of a compact speech module in accordance with another aspect of the invention.

FIG. 2A is a block diagram illustrating the form factor of a compact speech module in accordance with one aspect of the invention.

FIG. 2B is a block diagram illustrating the form factor of a compact speech module in accordance with another aspect of the invention.

FIG. 2C is a block diagram illustrating the form factor of a compact speech module in accordance with another aspect of the invention.

FIG. 3A is a block diagram illustrating one aspect of the detachable connection for connecting the compact speech module to a host device.

FIG. 3B is a block diagram illustrating another aspect of the detachable connection for connecting the compact speech module to a host device.

FIG. 3C is a block diagram illustrating a further aspect of the detachable connection for connecting the compact speech module to a host device.

### DETAILED DESCRIPTION OF THE INVENTION

The invention discloses a form factor for a compact speech module for use with a host computing device. The compact speech module can process speech independently of the host device. More particularly, the compact speech module can contain software and hardware components necessary for handling the speech processing requirements of the host device.

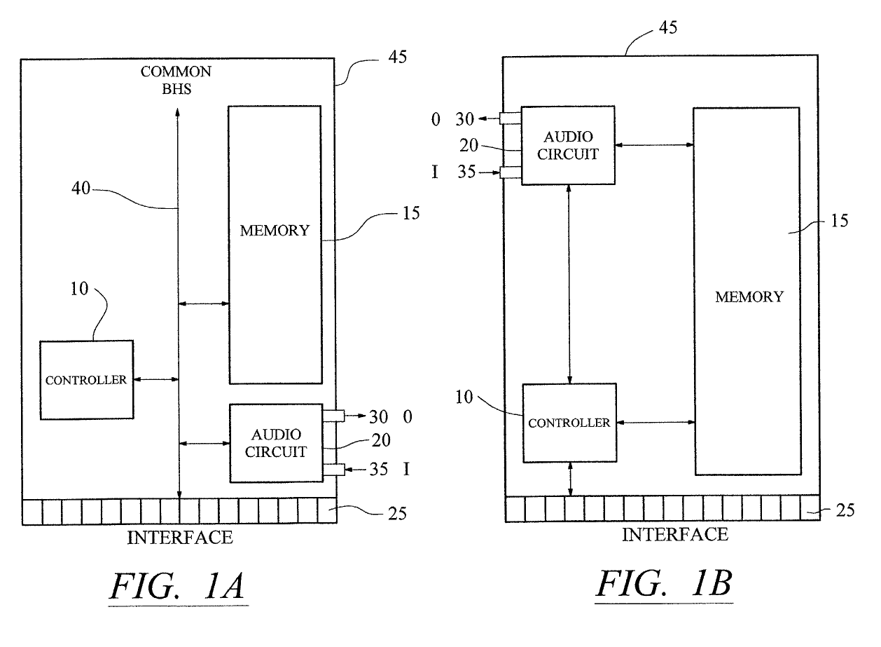

FIG. 1A illustrates a compact speech module configured in accordance with one aspect of the invention. With reference to FIG. 1A, the compact speech module can have a controller or processor 10, a common communication data and control bus 40, audio circuitry 20, memory 15, a computing device interface 25, and a housing 45. The controller or processor 10 can be a microprocessor, a micro-controller, a Field Programmable Gate Array (FPGA), an Application Specific Integrated Circuit (ASIC), or other similar device. In the case of an FPGA or ASIC, the FPGA or ASIC can be programmed or designed to facilitate specific control of the speech processing tasks to be carried out by the various components of the compact speech module. For example, although a processor can execute code, a controller, need not have the ability to execute code. Rather, the controller can function as an interface or state machine for executing functions such as converting parallel signals to serial signals and routing signals to their proper destination components within the compact speech module.

The common communication data and control bus 40 can be an electrical conduit that facilitates the transmission of electrical signals between the controller 10, audio circuitry 20, memory 15, and interface 25. The various components of the compact speech module can communicate with each other via the common data and control bus 40. Common data and control buses are well known by those skilled in the art. The common data and control bus 40 also can include corresponding common data and control bus control circuitry for controlling electronic transmissions in the common data and control bus 40.

The audio circuitry 20 can be a conventional audio processor. As such, the audio circuitry 20 can include circuitry for converting an analog signal to a digital signal and for converting a digital signal to an analog signal. In one aspect of the invention, the invention can include a 16-bit or greater Analog-to-Digital (A/D) converter, a 16-bit or greater Digital-to-Analog (D/A) converter, a programmable microphone gain electronic circuitry, output attenuation electronics circuitry and a serial communication interface. Although the compact speech module includes a 16-bit A/D and D/A converters, it should readily be understood by those skilled in the art that other A/D and D/A converters with different processing resolutions can be used without departing from the spirit of the invention.

The programmable microphone gain circuitry can be connected to an input external connector 35 that can facilitate the connection of an external microphone. The output attenuation electronics circuitry can be connected to an output external connector 30 that can facilitate the connection of an external speaker or headphones. In an alternate embodiment, for example in the case of a headset speaker / microphone combination, the input and output external connectors for facilitating the connection of the microphone and the external speaker or headphone respectively, can be integrated into a single connector or jack. In either embodiment, the connectors or jacks for facilitating the connection of a microphone and/or a speakers (headphones) can be placed, for example, at the opposite end of the compact speech module bearing the device interface 25. In a further embodiment of the invention, the audio and/or speaker connectors (jacks) can be connected to available pins on the device interface 25. This can facilitate use of the host device built-in or connected microphones and/or speakers. The audio component can be composed of discrete components and/or packaged into an integrated circuit.

The memory 15 can be conventional memory used to store data. Memory 15 notably, can be non-volatile memory, and more particularly flash memory. Since flash memory can be quickly erased and rewritten in blocks, updates to the program code resident in the memory can be made almost instantaneously. Alternative forms of flash memory also can be used as memory 15, for example NOR-based and NAND-based flash, or other quickly erasable and re-writable non-volatile memory (NVM). Although the memory 15 is illustrated as a single block, it should readily be understood by those skilled in the art that the memory 15 can be comprised of a plurality of memory chips. Furthermore, the storage capacity of the memory 15 can vary according to the processing and storage requirements.

The computing device interface 25 can be any suitable device interface that can facilitate connection to a PC or other host device. Computing device interface 25 can conform to the personal computer memory card international association (PCMCIA) specifications and can be implemented as a type 1, type 11, or type III PCMCIA device. The compact speech module computing device interface 25 can have a standard 68 pin connector that allows connection to devices conforming with the PC card specification.

The PCMCIA and PC card standards are well known in the art and facilitate the interoperability of PC cards for various applications including PC's and electronics such as cameras, set-top boxes and mobile computing handheld devices such as PDA's and palm held devices. These devices all can act as host devices for the compact speech module. The form factor of the compact module card allows it to be compatible with handheld mobile computing devices which economize on size.

In alternate embodiments, the compact speech module computing device to interface 25 can be configured to fit any host device interface. An adapter also can be used to facilitate connection to host devices having varying pin configurations. For example, an adapter card can be used to mate the device interface 25 with the device interface of a host that does not follow the PC card specification. This can permit a plethora of host devices to communicate and exchange data with the compact speech module. It should be readily understood by those skilled in the art that the device interface 25 is not limited to a PCMCIA configuration. Other exemplary device interfaces can include, but are not limited to, Compact Flash, Miniature Card, CardBus, PCI, ISA, Serial, Parallel, USB, or SmartMedia interfaces. Although the compact speech module can be connected to a host computing device via a male and female plug and socket interface arrangement, a wire arrangement, for example, a ribbon cable, could be used to facilitate a detachable connection for the device. In another aspect of the invention, the detachable connection can be connector pins that make contact with connector pins on the host device.

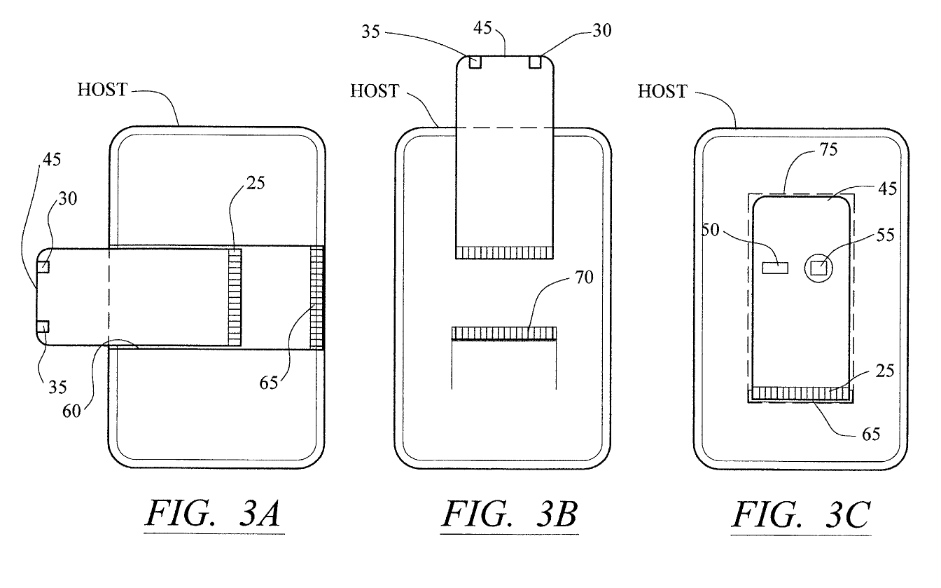

FIG. 3A illustrates one aspect of the detachable connection for connecting the compact speech module to a host device. In FIG. 3A, the host device can contain a slot 60 located at the side of the host device, and into which the housing of the compact speech module can be inserted. Once the compact speech module is fully inserted, the interface 25 can make electrical contact with the connector 65 of the host device.

FIG. 3B illustrates another aspect of the detachable connection for connecting the compact speech module to a host device. In FIG. 3B, the host device can contain a connector 70 for connecting with the interface 25 of the compact speech module.

FIG. 3C illustrates a further aspect of the detachable connection for connecting the compact speech module to a host device. In FIG. 3C, the host device can contain an opening well 75 in the host device for accommodating the housing 45 of the compact speech module. Once the compact speech module is fully installed within the opening well 75, the interface 25 connects with the connector 65 of the host device. A is cover can be placed over the opening 75 so that the compact speech module is encased within the host device.

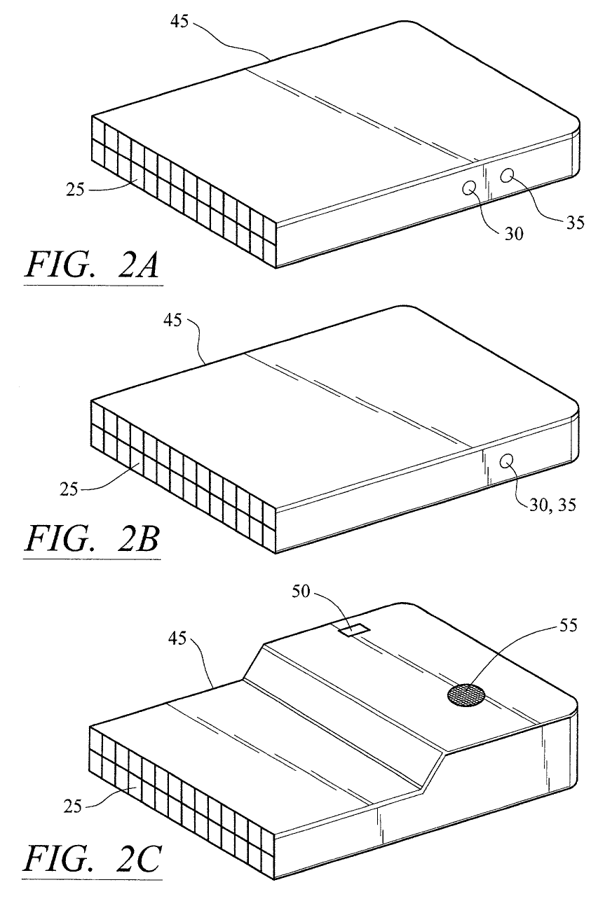

The housing 45 can contain within its dimensions, the controller 10, the audio circuitry 20, the memory 15 and common data and control bus 40. The interface 25 can be located at one end of the housing 45. External connector 30 can facilitate the connection of an output device, for example, a speaker or headphone. External connector 35 can facilitate the connection of an input device, for example, a microphone. The external connectors 30 and 35 can be located at the side of housing 45 as shown in FIG. 2A. In another aspect of the invention, the connectors 30 and 35 can be located at the opposite end of the interface 25. FIG. 2B illustrates another aspect of the invention wherein the connectors 30 and 35 can be combined into a single connector of the variety commonly used in conjunction with headset units having both a speaker and a microphone.

FIG. 2C illustrates another aspect of the invention in which the compact speech module contains an external microphone 50 and an external speaker 55, both of which can be located on the surface of the housing 45. In another aspect of the invention, the external microphone 50 and the external speaker 55 can be located on any face or side of the housing 45. Notably, the housing 45 can be increased in thickness to accommodate the external microphone 50 and the external speaker 55. It should be appreciated, however, that the increased housing thickness in a function of the size of the external speaker 55 and external microphone 50. Accordingly, if suitably sized components are utilized, the external housing 45 need not have an increased thickness as shown in FIG. 2C. Regardless, the manner in which the compact speech module is connected to the host device can dictate where the external microphone 50, the external speaker 55, the external connector 30, and the external connector 35 are located on the housing 45. The housing 45 can be made of electrically insulating material that can act as a radiation shield.

In operation, the controller 10 can control the signals which allow communication between the memory 15 and the audio circuitry 20. For example, analog signals entering the audio circuitry 20 through external inputs 35 can be processed by the audio circuitry and the resulting digitized audio data signals can be communicated to the memory 15 under the control of controller 10. Digitized audio data can then be stored in memory 15 for processing by a speech recognition engine. After the speech recognition engine has received and processed the digitized audio data, the controller 10 can communicate the resulting digital signal to the audio circuitry 20 and/or the host device. For signals destined for the host device, the controller 10 can communicate the information through the computing device interface 25.

Alternatively, the speech recognition algorithm code, which can be referred to as a speech recognition engine, can be communicated to the host computing device for execution. In that case, the compact speech module can store code, data, speech, and resulting text, in addition to providing analog to digital and digital to analog conversion. Accordingly, the compact speech module does not execute the speech algorithm code to perform the actual speech recognition. Rather, digital audio signals can be communicated to the host computing device to perform the actual speech recognition after the speech recognition algorithm code has been communicated to the host computing device. The resulting text can be communicated to the compact speech module to be stored within the memory 15.

In operation, the memory 15 can act as a store for program code and data. The memory 15 also can store speech recognition algorithm code. Digitized information received, for example, digitized audio signals from the audio circuitry 20, can be stored in the memory 15. The controller can then execute the recognition algorithm on the digitized data stored in the memory 15. The processed information can be dispatched to the audio circuitry 20 and/or the host device via the device interface 25.

In a further aspect of the invention, in operation, the memory 15 also can act as a temporary repository for captured speech. Using deferred dictation capabilities, the compact speech module can be plugged into a host device, where the speech captured on the compact speech module can be run against a large vocabulary speech recognition engine to facilitate complete dictation of memos, notes, letters or other documents. The host device could be a PC, handheld computer, laptop, palm held device, PDA, or any device having the necessary information processing capability.

FIG. 1 B is a block diagram illustrating an alternate configuration for a compact speech module. In the configuration illustrated in FIG. 1 B, unlike the configuration of FIG. 1A, there is no common communication data and control bus 40. Rather, in the configuration of FIG. 1 B, the control and data paths of the components that communicate with each other are variously connected.

While exemplary systems and methods embodying the present invention are shown by way of example, it should be understood that the invention is not limited to these embodiments. Modifications can be made by those skilled in the art, particularly in light of the foregoing teachings. For example, each of the elements of the aforementioned embodiments may be utilized alone or in combination with elements of the other embodiments.

What is claimed is:

1. A form factor for a compact speech module for use with a host computing device, comprising:
a housing;
a controller located within said housing;
memory for storing program code and data, said memory interconnected to said controller;
audio processing circuitry interconnected to said controller and said memory,
wherein said audio processing circuitry is configured to convert analog audio signals to digital audio data signals, and to convert digital audio data signals to analog audio signals;
a speech recognition engine for processing said digital audio data signals into speech recognized data, said speech recognition engine stored in said memory; and a computing device interface interconnected to said controller for detachably connecting the compact speech module to the host computing device, and through which said speech recognized data signals or said digital audio data signals can be communicated to the host device.

2. The compact speech module according to claim 1, wherein said controller is at least one selected from the group consisting of a microprocessor, a micro-controller, an ASIC and a FPGA.

3. The compact speech module according to claim 1, wherein said audio processing circuitry comprises electronics for receiving analog input speech signals and converting said signals to a 16-bit digital data, and for receiving a 16-bit digital data and converting said 16-bit digital data to an analog speech signal.

4. The compact speech module according to claim 1, wherein said audio processing circuitry is an integrated circuit.

5. The compact speech module according to claim 1, wherein said audio processing circuitry further comprises at least one selected from the group consisting of a programmable microphone gain, an output attenuator and a serial communication interface.

6. The compact speech module of claim 5, wherein said microphone gain circuitry 2 is connected to an externally accessible microphone connector, said connector located on the outside of said housing.

7. The compact speech module of claim 5, wherein said output attenuator circuitry is connected to an externally accessible speaker connector, said connector located in the outside of said housing.

8. The compact speech module according to claim 1, wherein said controller comprises circuitry for controlling the communication of said signals between said memory and said audio processing circuitry, and between said memory and said host device via said computing device interface.

9. The compact speech module according to claim 1, wherein said speech recognition engine is resident in said memory for storing code and data.

10. The compact speech module according to claim 1, wherein said memory can be a storage for digitized speech data.

11. The compact speech module according to claim 1, wherein said memory is a high speed memory.

12. The compact speech module according claim I, wherein said memory is a flash memory.

13. The compact speech module according to claim 1, wherein said computing device interface is located at the periphery of said housing.

14. The compact speech module according to claim 1, further comprising a microphone located on said housing, said microphone connected to said audio processing circuitry.

15. The compact speech module according to claim 1, further comprising a speaker located on said housing, said speaker connected to said audio processing circuitry.

16. The compact speech module according to claim 5, wherein said output attenuator circuitry and said programmable microphone gain circuitry are connected to a single headset connector.

17. The compact speech module of claim 1, wherein said speech recognition engine is communicated to said host computing device for execution.

18. The compact speech module of claim 1, wherein said speech recognition engine executes within said compact speech module.
